(19) United States
(12) Patent Application Publication
(10) Pub. No.: US 2017/0294185 A1
(43) Pub. Date: Oct. 12, 2017

(54) SEGMENTATION USING PRIOR DISTRIBUTIONS

(71) Applicant: KnuEdge Incorporated, San Diego, CA (US)

(72) Inventors: David Carlson Bradley, San Diego, CA (US); Sean O'Connor, San Diego, CA (US); Jeremy Semko, San Diego, CA (US)

(21) Appl. No.: 15/481,403

(22) Filed: Apr. 6, 2017

Related U.S. Application Data
(60) Provisional application No. 62/320,261, filed on Apr. 8, 2016.
(60) Provisional application No. 62/320,291, filed on Apr. 8, 2016.
(60) Provisional application No. 62/320,328, filed on Apr. 8, 2016.

(51) Int. Cl. G10L 15/04; G10L 15/14; G10L 15/02

(52) U.S. Cl. CPC G10L 15/04; G10L 15/02; G10L 15/14

(57) ABSTRACT

The technology described in this document can be embodied in a computer-implemented method that includes obtaining a speech signal, and estimating a first set and a second set of segment boundaries using the speech signal. The first and second set of segment boundaries are determined using a first and second segmentation process, respectively. The second segmentation process is different from the first segmentation process. The method also includes obtaining a model corresponding to a distribution of segment boundaries, computing a first score indicative of a degree of similarity between the model and the first set of segment boundaries, and computing a second score indicating a degree of similarity between the model and the second set of segment boundaries. The method further includes selecting a set of segment boundaries using the first score and the second score, and processing the speech signal using the selected set of segment boundaries.

### PRIORITY CLAIM

This application claims priority to U.S. Provisional Application 62/320,328, U.S. Provisional Application 62/320,291, and U.S. Provisional Application 62/320,261, each of which was filed on Apr. 8, 2016. The entire content of each of the foregoing applications is incorporated herein by reference.

### TECHNICAL FIELD

This document relates to signal processing techniques used, for example, in speech processing.

### BACKGROUND

Segmentation techniques are used in speech processing to divide the speech into utterances such as words, syllables, or phonemes.

### SUMMARY

In one aspect, this document features a computer-implemented method that includes obtaining a speech signal, and estimating, by one or more processing devices, a first set of segment boundaries and a second set of segment boundaries using the speech signal. The first set and the second set of segment boundaries are determined using a first segmentation process and a second segmentation process, respectively. The second segmentation process is different from the first segmentation process. The method also includes obtaining a model corresponding to a distribution of segment boundaries, computing a first score indicative of a degree of similarity between the model and the first set of segment boundaries, and computing a second score indicating a degree of similarity between the model and the second set of segment boundaries. The method further includes selecting a set of segment boundaries using the first score and the second score, and processing the speech signal using the selected set of segment boundaries.

In another aspect, this document features a system that includes memory and a segmentation engine that includes one or more processing devices. The one or more processing devices are configured to obtain a speech signal, and estimate a first set and a second set of segment boundaries using the speech signal. The first set and second set of segment boundaries are determined using a first segmentation process and a second segmentation process, respectively. The second segmentation process is different from the first segmentation process. The one or more processing devices are also configured to obtain a model corresponding to a distribution of segment boundaries, compute a first score indicative of a degree of similarity between the model and the first set of segment boundaries, and compute a second score indicating a degree of similarity between the model and the second set of segment boundaries. The one or more processing devices are further configured to select a set of segment boundaries using the first score and the second score, and process the speech signal using the selected set of segment boundaries.

In another aspect, this document features one or more machine-readable storage devices having encoded thereon computer readable instructions for causing one or more processors to perform various operations. The operations include obtaining a speech signal, and estimating, by one or more processing devices, a first set of segment boundaries and a second set of segment boundaries using the speech signal. The first set and the second set of segment boundaries are determined using a first segmentation process and a second segmentation process, respectively. The second segmentation process is different from the first segmentation process. The operations also include obtaining a model corresponding to a distribution of segment boundaries, computing a first score indicative of a degree of similarity between the model and the first set of segment boundaries, and computing a second score indicating a degree of similarity between the model and the second set of segment boundaries. The operations further include selecting a set of segment boundaries using the first score and the second score, and processing the speech signal using the selected set of segment boundaries.

Implementations of the above aspects may include one or more of the following features.

Computing the first score can include computing a first distribution function associated with the first set of boundaries. The first distribution function can be representative of an attribute associated with speech segments within the speech signal. The first score can be computed based on a degree of statistical similarity between (i) the first distribution function and (ii) the model, the model being representative of the attribute associated with speech segments identified from speech signals in a training corpus. Computing the second score can include computing a second distribution function associated with the second set of boundaries, wherein the second distribution function is also representative of the attribute, and computing the second score based on a degree of statistical similarity between (i) the second distribution function and (ii) the model. Selecting the set of segment boundaries using the first score and the second score can include determining that the first score is higher than the second score or the second score is higher than the first score. Responsive to determining that the first score is higher than the second score, the first set of segment boundaries can be selected as the set of segment boundaries. Responsive to determining that the second score is higher than the first score, the second set of segment boundaries can be selected as the set of segment boundaries.

Estimating the first set of segment boundaries or the second set of segment boundaries can include obtaining a plurality of frequency representations by computing a frequency representation of each of multiple portions of the speech signal, generating a time-varying data set using the plurality of frequency representations by computing a representative value of each frequency representation of the plurality of frequency representations, and determining the first set of segment boundaries or the second set of segment boundaries using the time-varying data set. The representative value of each frequency representation can be a stripe function value associated with the frequency representation.

Computing the frequency representation can include computing a stationary spectrum. The representative value of each frequency representation can be an entropy of the frequency representation. The first segmentation process can be different from the second segmentation process with respect to a parameter associated with each of the segmentation processes. The attribute can include one of: a duration of speech segments, a width of time-gap between consecutive speech segments, a number of speech segments within an utterance, a number of speech segments per unit time, or a duration between starting points of consecutive speech segments. Each of the first distribution function and the second distribution function can be a cumulative distribution function (CDF) or a probability density function (PDF). Each of the first score and the second score can be indicative of a goodness-of-fit between the model and the corresponding one of the first and second distribution function. The goodness-of-fit can be computed based on a Kolmogorov-Smirnov test between the model and the corresponding one of the first and second distribution functions. Processing the speech signal can include performing one of: speech recognition or speaker identification.

Various implementations described herein may provide one or more of the following advantages. By validating the output of a segmentation process using a model generated from training data, the reliability of the segmentation process may be improved. This in turn may allow the segmentation process to be usable for various types of noisy and/or distorted signals such as speech signals collected in noisy environments. By improving the accuracy of a segmentation technique, accuracies of speech processing techniques (e.g., speech recognition, speaker identification etc.) using the segmentation technique may also be improved.

### BRIEF DESCRIPTION OF THE DRAWINGS

FIG. 1 is a block diagram of an example of a network-based speech processing system that can be used for implementing the technology described herein.

FIG. 2A is a spectral representation of speech captured over a duration of time.

FIG. 2B is a plot of a time-varying function calculated from the spectral representation of FIG. 2A.

FIG. 2C is a smoothed version of the plot of FIG. 2B.

FIG. 3A is a plot of an example of a time-varying function that shows how varying threshold choices affect identification of segment boundaries.

FIG. 3B is a plot of another example of a time-varying function.

FIGS. 4A-4F are examples of distribution functions calculated from speech samples in a training corpus.

FIG. 5 is a flowchart of an example process for determining segment boundaries in accordance with technology described herein.

FIGS. 6A and 6B illustrate segmentation results generated using the technology described herein.

FIGS. 7A-7D are examples of speaker-specific distributions of various attributes associated with segments in speech signals.

FIG. 8 shows examples of a computing device and a mobile device.

### DETAILED DESCRIPTION

This document describes a segmentation technique in which multiple candidate sets of segment boundaries within a speech signal are estimated using different segmentation processes, and one of the estimated sets of segment boundaries is selected as the final result based on a degree of similarity with a precomputed model. The selection process includes evaluating one or more segment parameters calculated from each of the estimated sets, and selecting the set for which the one or more segment parameters most closely resemble corresponding segment parameters computed from the model that is generated based on a training corpus. In some implementations, a segment parameter can represent a density associated with an attribute of the segments, such as the number of segments/unit time. In some implementations, a segment parameter can represent a parameter of a distribution (e.g., a cumulative distribution function (CDF), a probability density function (PDF), or a probability mass function (PMF)) associated with the segments. In this document, computing a distribution for an attribute is used interchangeably with computing a segment parameter for the attribute.

In essence, the training corpus includes data (e.g., segmented speech) that is deemed reliable, the characteristics of which are usable in analyzing signals received during run-time. A candidate distribution corresponding to an attribute associated with each of the estimated set of segments can be computed and then checked against a distribution of the corresponding attribute computed from the training data. Accordingly, a score can be generated for each of the candidate distributions, wherein the score is indicative of the degree of similarity of the corresponding candidate distribution to the distribution computed from the training data. The set of segments corresponding to the distribution with the highest score is then selected as the set that is used for further processing the speech signal. In some implementations, the attribute for which the distributions are computed can include a segment timing characteristic such as segment width, width of gaps between segments, number of segments per second, etc. The distributions can be represented by corresponding distribution functions (e.g., a probability density function (PDF) or cumulative distribution function (CDF)) computed for the attribute. In some implementations, a segment can include multiple phonations with intervening gaps. In some implementations, a segment includes a phonated portion without any gaps. In such cases, the segment may also be referred to as a stack.

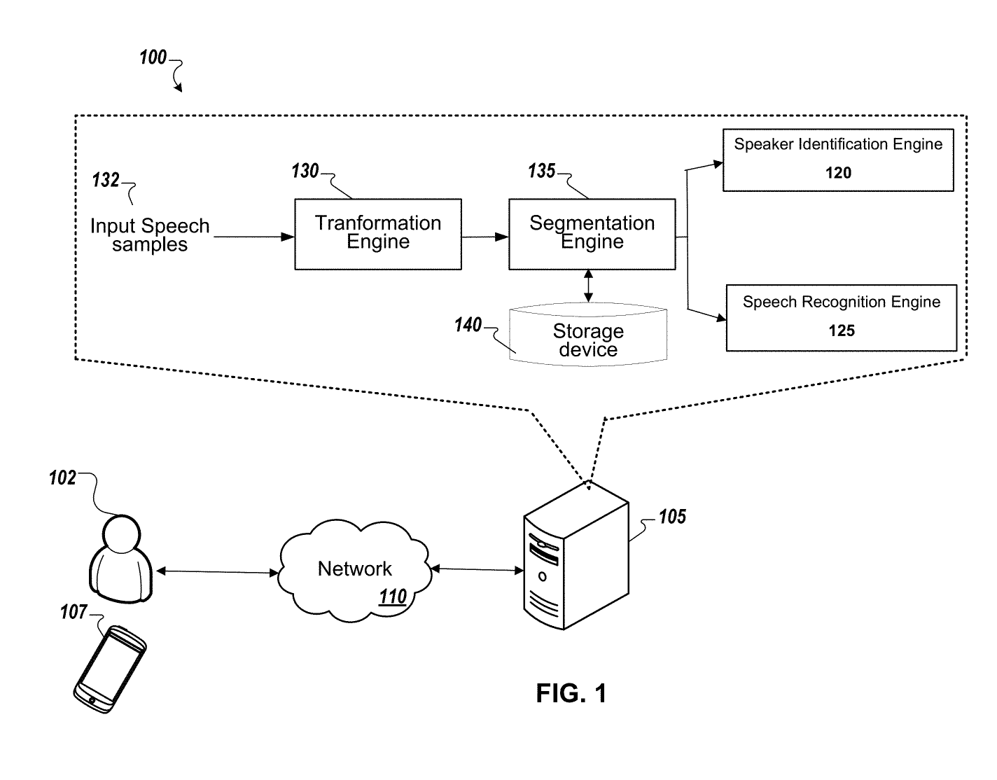

FIG. 1 is a block diagram of an example of a network-based speech processing system 100 that can be used for implementing the technology described herein. In some implementations, the system 100 can include a server 105 that executes one or more speech processing operations for a remote computing device such as a mobile device 107. For example, the mobile device 107 can be configured to capture the speech of a user 102, and transmit signals representing the captured speech over a network 110 to the server 105. The server 105 can be configured to process the signals received from the mobile device 107 to generate various types of information. For example, the server 105 can include a speaker identification engine 120 that can be configured to perform speaker recognition, and/or a speech recognition engine 125 that can be configured to perform speech recognition.

In some implementations, the server 105 can be a part of a distributed computing system (e.g., a cloud-based system) that provides speech processing operations as a service. For example, the server may process the signals received from the mobile device 107, and the outputs generated by the server 105 can be transmitted (e.g., over the network 110) back to the mobile device 107. In some cases, this may allow outputs of computationally intensive operations to be made available on resource-constrained devices such as the mobile device 107. For example, speech classification processes such as speaker identification and speech recognition can be implemented via a cooperative process between the mobile device 107 and the server 105, where most of the processing burden is outsourced to the server 105 but the output (e.g., an output generated based on recognized speech) is rendered on the mobile device 107. While FIG. 1 shows a single server 105, the distributed computing system may include multiple servers (e.g., a server farm). In some implementations, the technology described herein may also be implemented on a stand-alone computing device such as a laptop or desktop computer, or a mobile device such as a smartphone, tablet computer, or gaming device.

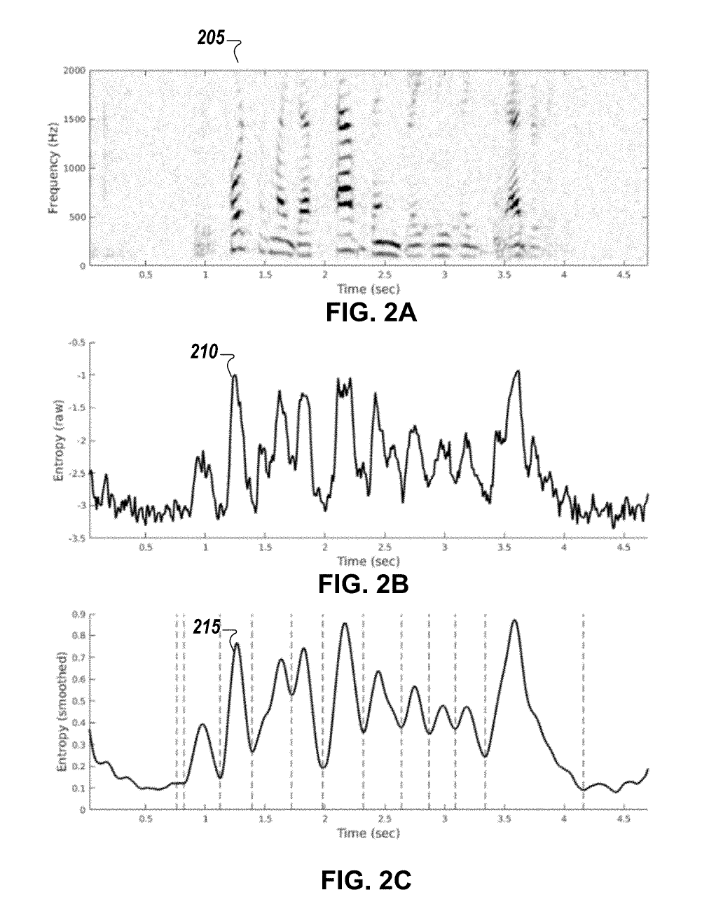

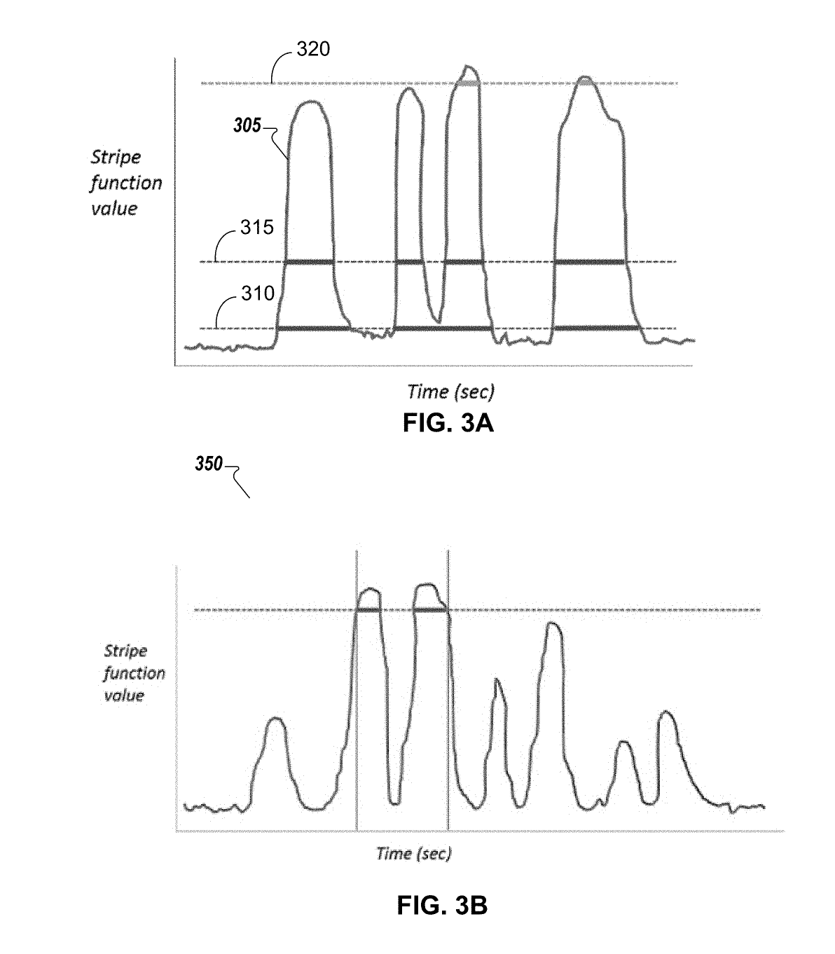

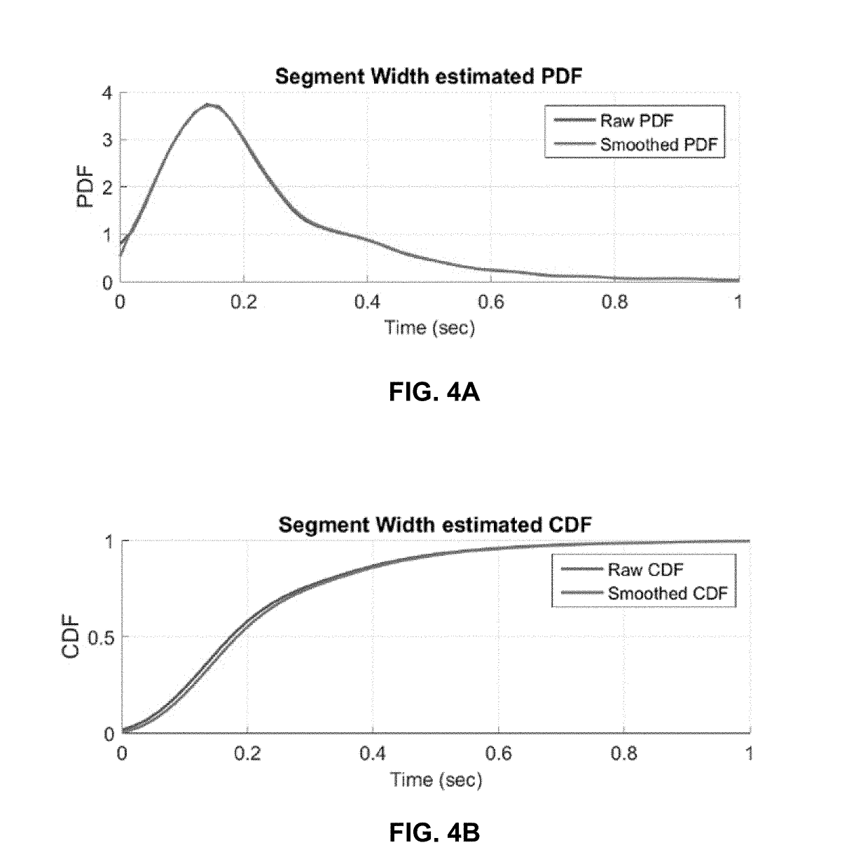

In some implementations, a signal such as input speech may be segmented via analysis in a different domain (e.g., a non-time domain such as the frequency domain). In such cases, the server 105 can include a transformation engine 130 for generating a spectral representation of speech from input speech samples 132. In some implementations, the input speech samples 132 may be generated, for example, from the signals received from the mobile device 107. In some implementations, the input speech samples may be generated by the mobile device and provided to the server 105 over the network 110. In some implementations, the transformation engine 130 can be configured to process the input speech samples 132 to obtain a plurality of frequency representations, each corresponding to a particular time point, which together form a spectral representation of the speech signal. This can include computing corresponding frequency representations for a plurality of portions of the speech signal, and combining them together in a unified representation. For example, each of the frequency representations can be calculated using a portion of the input speech samples 132 within a sliding window of predetermined length (e.g., 60 ms). The frequency representations can be calculated periodically (e.g., every 10 ms), and combined to generate the unified representation. An example of such a unified representation is the spectral representation 205 shown in FIG. 2A, where the x-axis represents frequencies and the y axis represents time. The amplitude of a particular frequency at a particular time is represented by the intensity or color or grayscale level of the corresponding point in the image. Therefore, a vertical slice that corresponds to a particular time point represents the frequency distribution of the speech at that particular time point, and the spectral representation in general represents the time variation of the frequency distributions.

The transformation engine 130 can be configured to generate the frequency representations in various ways. In some implementations, the transformation engine 130 can be configured to generate a spectral representation as outlined above. In some implementations, the spectral representation can be generated using one or more stationary spectrums. Such stationary spectrums are described in additional detail in U.S. application Ser. No. 14/969,029, filed on Dec. 15, 2015, the entire content of which is incorporated herein by reference. In some implementations, the transformation engine 130 can be configured to generate other forms of spectral representations (e.g., a spectrogram) that represent how the spectra of the speech varies with time.

In some implementations, speech classification processes such as speaker identification, speech recognition, or speaker verification entail dividing input speech into multiple small portions or segments. A segment may represent a coherent portion of the signal that is separated in some manner from other segments. For example, with speech, a segment may correspond to a portion of a signal where speech is present or where speech is phonated or voiced. For example, the spectral representation 205 (FIG. 2A) illustrates a speech signal where the phonated portions are visible and the speech signal has been broken up into segments corresponding to the phonated portions of the signal. To classify a signal, each segment of the signal may be processed and the output of the processing of a segment may provide an indication, such as a likelihood or a score, that the segment corresponds to a class (e.g., corresponds to speech of a particular user). The scores for the segments may be combined to obtain an overall score for the input signal and to ultimately classify the input signal.

In some implementations, the server 105 includes a segmentation engine 135 that executes a segmentation process in accordance with the technology described herein. The segmentation engine 135 can be configured to perform segmentation in various ways. In some implementations, a segmentation can be performed based on a portion of a signal, from a spectrum of a portion of the signal, or from feature vectors (e.g., harmonic amplitude feature vectors) computed from a portion of the signal. In some implementations, the segmentation engine 135 can be configured to receive as input a spectral representation that includes a frequency domain representation for each of multiple time points (e.g., the spectral representation 205 as generated by the transformation engine 130), and generate outputs that represent segment boundaries (e.g., as time points) within the input speech samples 132. The identified segment boundaries can then be provided to one or more speech classification engines (e.g., the speaker identification engine 120 or the speech recognition engine 125) that further process the input speech samples 132 in accordance with the corresponding speech segments. The segmentation engine 135 can be configured to access a storage device 140 that stores one or more pre-computed distributions corresponding to various attributes calculated from the model or trusted training corpus.

FIGS. 2A-2C illustrate an example of how the segmentation engine 135 generates identification of segment boundaries in input speech. The segment boundaries can be generated from a portion of the signal, from a spectrum of a portion of the signal, or from feature vectors (e.g., harmonic amplitude feature vectors) computed from a portion of the signal. The particular example of FIGS. 2A-2C illustrates a segmentation process that is based on a time-varying function generated from the input signal. Specifically, FIG. 2A is a spectral representation 205 corresponding to speech captured over a duration of time, FIG. 2B is a plot 210 of a time-varying function (in this particular example, an entropy function) calculated from the spectral representation of FIG. 2A, and FIG. 2C is a smoothed version 215 of the plot of FIG. 2B. The x-axis of the spectral representation 205 represents time, and the y-axis represents frequencies. Therefore, the data corresponding to a vertical slice for a given time point represents the frequency distribution at that time point. In some implementations the frequency representation may be a stationary spectrum as described in U.S. application Ser. No. 14/969,029, filed on Dec. 15, 2015, the entire content of which is incorporated herein by reference.

While FIGS. 2B and 2C show an entropy function as the time-varying function used in the segmentation process, other time-varying functions may also be used. In general, time-varying functions that include information for differentiating between segments of interest and non-segment portions may be used. For example, where the segment of interest corresponds to a segment containing speech, the function may be any function that indicates whether speech is present in a signal, such as a function that indicates an energy level of a signal or the presence of voiced speech. The time-varying functions that may be used for implementing the technology described herein may be referred to as stripe functions and are described in U.S. application Ser. No. 15/181,868, the entire content of which is incorporated herein by reference. In some implementations, the time-varying function can be an entropy function illustrated in FIGS. 2B and 2C. Computation of such entropy functions is described in U.S. application Ser. No. 15/372,205, the entire content of which is incorporated herein by reference.

The stripe functions may be computed directly from a portion of the signal, from a spectrum of a portion of the signal, or from feature vectors (e.g., harmonic amplitude feature vectors) computed from a portion of the signal. Various examples of stripe functions are provided below.

Some stripe functions may be computed from a spectrum (e.g., a fast Fourier transform or FFT) of a portion of the signal. For example, a portion of a signal may be represented as xₙ for n from 1 to N, and the magnitude of spectrum at the frequency fᵢ may be represented as Xᵢ for i from 1 to N. In some cases, Xᵢ may represent the complex valued spectrum at the frequency fᵢ. Stripe function moment1spec is the first moment, or expected value, of the FFT, weighted by the values:

$$moment 1 spec = μ = \frac{{\sum }_{i = 1}^{N} {X}_{i} {f}_{i}}{{\sum }_{i = 1}^{N} {X}_{i}} \qquad ( 1 )$$

Stripe function moment2spec is the second central moment, or variance, of the FFT frequencies, weighted by the values:

$$moment 2 spec = {σ}^{2} = \frac{{\sum }_{i = 1}^{N} {{X}_{i} ( {f}_{i} - μ )}^{2}}{{\sum }_{i = 1}^{N} {X}_{i}} \qquad ( 2 )$$

Stripe function totalEnergy is the energy density per frequency increment:

$$totalEnergy = \frac{1}{N} {\sum }_{i = 1}^{N} {X}_{i}^{2} \qquad ( 3 )$$

Stripe function periodicEnergySpec is a periodic energy measure of the spectrum up to a certain frequency threshold (such as 1 kHz). It may be calculated by (i) determining the spectrum up to the frequency threshold (denoted X_{C}), (ii) taking the magnitude squared of the Fourier transform of the spectrum up to the frequency threshold (denoted as X′), and (iii) computing the sum of the magnitude squared of the inverse Fourier transform of X′:

X′=| [symbol] {X_{C}}|² (4)

periodicEnergySpec=Σ| [symbol] ⁻¹{X′}|² (5)

Stripe function Lf (“low frequency”) is the mean of the spectrum up to a frequency threshold (such as 2 kHz):

$$Lf = \frac{1}{{N}^{′}} {\sum }_{i = 1}^{{N}^{′}} {X}_{i} \qquad ( 6 )$$

where N′ is a number less than N. Stripe function Hf (“high frequency”) is the mean of the spectrum above a frequency threshold (such as 2 kHz):

$$Hf = \frac{1}{N - {N}^{′} + 1} {\sum }_{i = {N}^{′}}^{N} {X}_{i} \qquad ( 7 )$$

Some stripe functions may be computed from a stationary spectrum of a portion of the signal. For a portion of a signal, let X′ᵢ represent the value of the stationary spectrum and fᵢ represent the frequency corresponding to the value for i from 1 to N. Additional details regarding the computation of a stationary spectrum are described in the U.S. application Ser. No. 14/969,029, incorporated herein by reference. Stripe function stationaryMean is the first moment, or expected value, of the stationary spectrum, weighted by the values:

$$stationaryMean = {μ}_{S} = \frac{{\sum }_{i = 1}^{N} {X}_{i}^{′} {f}_{i}}{{\sum }_{i = 1}^{N} {X}_{i}^{′}} \qquad ( 8 )$$

Stripe function stationaryVariance is the second central moment, or variance, of the stationary spectrum, weighted by the values:

$$stationaryVariance = {σ}_{S}^{2} = \frac{{\sum }_{i = 1}^{N} {{X}_{i}^{′} ( {f}_{i} - {μ}_{S} )}^{2}}{{\sum }_{i = 1}^{N} {X}_{i}^{′}} \qquad ( 9 )$$

Stripe function stationarySkewness is the third standardized central moment, or skewness, of the stationary spectrum, weighted by the values:

$$stationarySkewness = {γ}_{S} = \frac{{\sum }_{i = 1}^{N} {{X}_{i}^{′} ( {f}_{i} - {μ}_{S} )}^{3}}{{σ}_{S}^{3} {\sum }_{i = 1}^{N} {X}_{i}^{′}} \qquad ( 10 )$$

Stripe function stationaryKurtosis is the fourth standardized central moment, or kurtosis, of the stationary spectrum, weighted by the values:

$$stationaryKurtosis = {κ}_{S} = \frac{{\sum }_{i = 1}^{N} {{X}_{i}^{′} ( {f}_{i} - {μ}_{S} )}^{4}}{{σ}_{S}^{4} {\sum }_{i = 1}^{N} {X}_{i}^{′}} \qquad ( 11 )$$

Stripe function stationaryBimod is the Sarle's bimodality coefficient of the stationary spectrum:

$$stationaryBimod = {β}_{S} = \frac{{γ}_{S}^{2} + 1}{{κ}_{S}} \qquad ( 12 )$$

Stripe function stationaryPeriodicEnergySpec is similar to periodicEnergySpec except that it is computed from the stationary spectrum. It may be calculated by (i) determining the stationary spectrum up to the frequency threshold (denoted X′_{C}), (ii) taking the magnitude squared of the Fourier transform of the stationary spectrum up to the frequency threshold (denoted as X″), and (iii) computing the sum of the magnitude squared of the inverse Fourier transform of X″:

X″=| [symbol] {X′_{C}}|² (13)

stationaryPeriodicEnergySpec=Σ| [symbol] ⁻¹{X″}|² (14)

Some stripe functions may be computed from a log likelihood ratio (LLR) spectrum of a portion of the signal. For a portion of a signal, let X″ᵢ represent the value of the LLR spectrum and fᵢ represent the frequency corresponding to the value for i from 1 to N. Additional details regarding the computation of an LLR spectrum are described in the U.S. application Ser. No. 14/969,029, incorporated herein by reference. Stripe function evidence is the sum of the values all the LLR peaks where the values are above a threshold (such as 100). Stripe function KLD is the mean of the LLR spectrum:

$$KLD = \frac{1}{N} {\sum }_{i = 1}^{N} {X}_{i}^{″} \qquad ( 15 )$$

Stripe function MLP (max LLR peaks) is the maximum LLR value:

$$MLP = {max}_{i} {X}_{i}^{″} \qquad ( 16 )$$

Some stripe functions may be computed from harmonic amplitude features computed from a portion of the signal. Let N be the number of harmonic amplitudes, and mᵢ be the magnitude of the i^{th} harmonic, and aᵢ be the complex amplitude of the i^{th} harmonic for i from 1 to N. Stripe function mean is the sum of harmonic magnitudes, weighted by the harmonic number:

mean=Σᵢ₌₁^{N}imᵢ (17)

Stripe function hamMean is the first moment, or expected value, of the harmonic amplitudes, weighted by their values, where fᵢ is the frequency of the harmonic:

$$hamMean = {μ}_{H} = \frac{{\sum }_{i = 1}^{N} {m}_{i} {f}_{i}}{{\sum }_{i = 1}^{N} {m}_{i}} \qquad ( 18 )$$

Stripe function hamVariance is the second central moment, or variance, of the harmonic amplitudes, weighted by their values:

$$hamVariance = {σ}_{H}^{2} = \frac{{\sum }_{i = 1}^{N} {{m}_{i} ( {f}_{i} - {μ}_{H} )}^{2}}{{\sum }_{i = 1}^{N} {m}_{i}} \qquad ( 19 )$$

Stripe function hamSkewness is the third standardized central moment, or skewness, of the harmonic amplitudes, weighted by their values:

$$hamSkewness = {γ}_{H} = \frac{{\sum }_{i = 1}^{N} {{m}_{i} ( {f}_{i} - {μ}_{H} )}^{3}}{{σ}_{H}^{3} {\sum }_{i = 1}^{N} {m}_{i}} \qquad ( 20 )$$

Stripe function hamKurtosis is the fourth standardized central moment, or kurtosis, of the harmonic amplitudes, weighted by their values:

$$hamKurtosis = {κ}_{H} = \frac{{\sum }_{i = 1}^{N} {{m}_{i} ( {f}_{i} - {μ}_{H} )}^{4}}{{σ}_{H}^{4} {\sum }_{i = 1}^{N} {m}_{i}} \qquad ( 21 )$$

Stripe function hamBimod is the Sarle's bimodality coefficient of the harmonic amplitudes weighted by their values:

$$hamBimod = {β}_{H} = \frac{{γ}_{H}^{2} + 1}{{κ}_{H}} \qquad ( 22 )$$

Stripe function H1 is the absolute value of the first harmonic amplitude:

H1=|a₁| (23)

Stripe function H1to2 is the norm of the first two harmonic amplitudes:

H1to2=\sqrt{|a₁|²+|a₂|²} (24)

Stripe function H1to5 is the norm of the first five harmonic amplitudes:

H1to5=\sqrt{|a₁|²+|a₂|²+|a₃|²+|a₄|²+|a₅|²} (25)

Stripe function H3to5 is the norm of the third, fourth, and fifth harmonic amplitudes:

H3to5=\sqrt{|a₃|²+|a₄|²+|a₅|²} (26)

Stripe function meanAmp is the mean harmonic magnitude:

$$meanAmp = \frac{1}{N} {\sum }_{i = 1}^{N} {m}_{i} \qquad ( 27 )$$

Stripe function harmonicEnergy is calculated as the energy density:

$$harmonicEnergy = \frac{1}{N} {\sum }_{i = 1}^{N} {m}_{i}^{2} \qquad ( 28 )$$

Stripe function energyRatio is a function of harmonic energy and total energy, calculated as the ratio of their difference to their sum:

$$energyRatio = \frac{harmonicEnergy - totalEnergy}{harmonicEnergy + totalEnergy} \qquad ( 29 )$$

In some implementations, a stripe function may also be computed as a combination of two or more stripe functions. For example, a function c may be computed at 10 millisecond intervals of the signal using a combination of stripe functions as follows:

c=KLD+MLP+harmonicEnergy (30)

In some implementations, the individual stripe functions (KLD, MLP, and harmonicEnergy) may be z-scored before being combined to compute the function c. The function c may then be smoothed by using any appropriate smoothing technique, such as Lowess smoothing. In another example, a function p may be computed at 10 millisecond intervals of the signal using the stripe functions as follows:

p=H1to2+Lf+stationaryPeriodicEnergySpec (31)

In some implementations, the individual stripe functions (H1to2, Lf, and stationaryPeriodicEnergySpec) may be z-scored before being combined to compute the function p. The function p may then be smoothed by using any appropriate smoothing technique, such as Lowess smoothing. In another example, a function h may be computed at 10 millisecond intervals of the signal using a combination of stripe functions as follows:

h=KLD+MLP+H1to2+harmonicEnergy (32)

In some implementations, the individual stripe functions (KLD, MLP, H1to2, and harmonicEnergy) may be z-scored before being combined to compute the function h. The function h may then be smoothed by using any appropriate smoothing technique, such as Lowess smoothing.

The technology described herein includes generating candidate sets of segments or segment boundaries from one or more time-varying functions computed from an incoming signal. For example, candidate segment boundaries may be generated from an entropy function (e.g., as illustrated in FIGS. 2B and 2C) or one or more of the stripe functions described above, and then a particular candidate can be selected such that a distribution of an attribute for the selected candidate resembles the distribution of the same attribute as computed from the training data. The different candidate sets of segments can be generated in various ways. In some implementations, the multiple candidate sets of segments may be generated using different stripe functions for each. In some implementations, the multiple candidate sets of segments can be generated using substantially the same stripe function, but varying one or more parameters used for generating the candidate sets of segments. For example, when a stripe function is thresholded to generate a candidate set of segments, the threshold may be used as the parameter that is varied in generating the candidate segments, and the threshold that generates a distribution of segments substantially similar to that obtained from the model may be used.

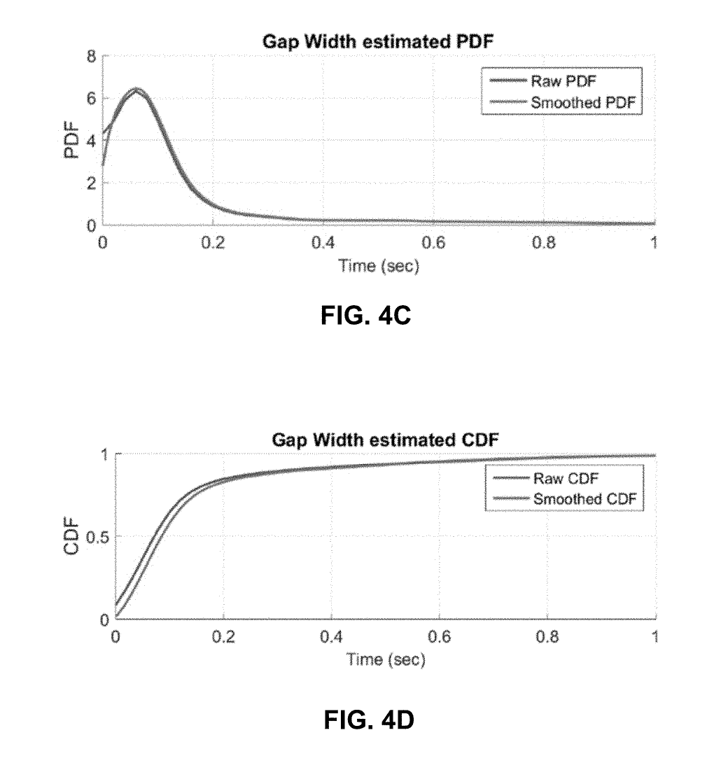

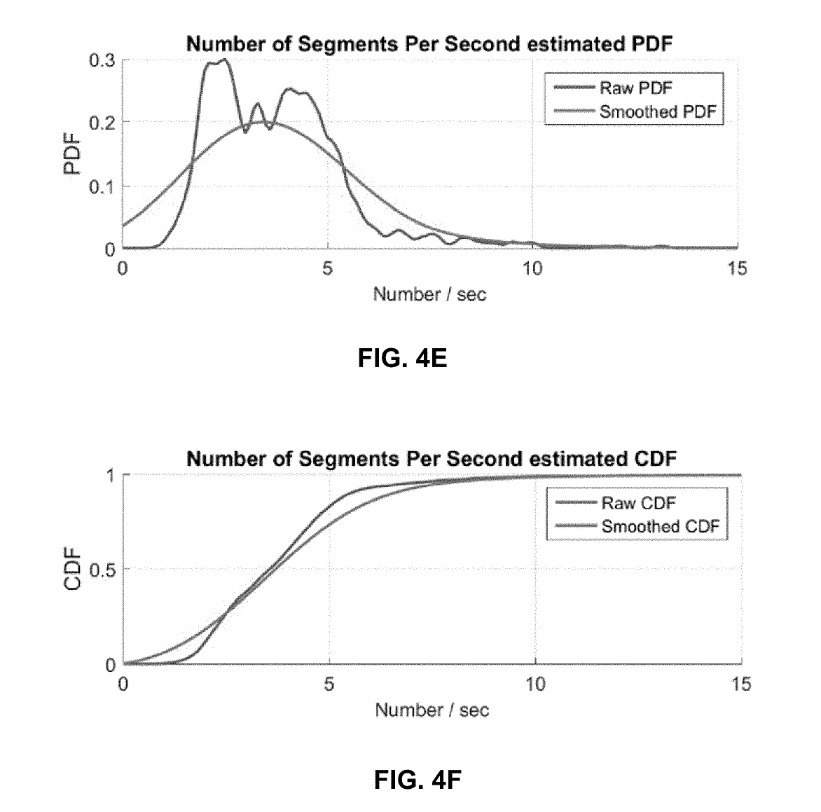

FIG. 3A illustrates the effect of varying the threshold using a generic stripe function 305. In practice, a stripe function that tends to rise in phonation regions (e.g. MLP, KLP, Evidence, etc.) can be used. The thresholds 310, 315, and 320 represent three different choices of threshold used for identifying segment boundaries (e.g., as the points at which the stripe function crosses the threshold). If the threshold is too low (e.g., threshold 310) multiple phonations may be erroneously grouped into a single segment. On the other hand, if threshold is too high (e.g., threshold 320), many true phonations may be missed, and the ones that are detected may have overly narrow segment-widths. Therefore, it may be desirable to find an “optimal” threshold choice (e.g., the threshold 315), such that the resulting segment boundaries correspond well with the edges of phonation.

In some cases, determining such an optimal threshold (or another optimal parameter associated with a segmentation process) can be challenging, particularly in the presence of noise. This document features technology that allows for the threshold to be varied adaptively until the resulting segments exhibit attributes (segment widths, widths of gaps between segments, number of segments per utterance, number of segments per unit time, widths of duration between segment starting points, etc.) that are substantially similar to corresponding attributes computed from a model or training corpus. In some implementations, candidate sets of segment boundaries for different thresholds may be evaluated, and the threshold for which the segment characteristics best match those obtained from the model may be selected. For example, a range of threshold values spanning the stripe function (e.g., a low value to a high value) may be used in generating correspondingly different sets of candidate segments. In some implementations, the threshold values may be substantially uniformly-spaced in percentiles of the stripe function. For a certain range of the threshold values, the corresponding candidate sets of segments (or segment boundaries) may have timing properties or attributes that are consistent with the corresponding attributes obtained from distributions of the model or training corpus. The distribution of an attribute of each such candidate set may be compared to a corresponding distribution generated from the model and assigned a score based on a degree of similarity to the model distribution. Upon determining the scores, the candidate set of segment boundaries that corresponds to the highest score may be selected for further processing. In some implementations, a candidate set may be selected upon determining that the corresponding score is indicative of an acceptable degree of similarity. In some cases, such an adaptive technique may improve the accuracy of the segmentation process, particularly in the presence of noise or other distortions, and by extension that of the speech processing techniques that use the segmentation results.

In some implementations, it may be possible to set an absolute floor for the thresholds used in generating the candidate sets of segment boundaries based on, for example, specific characteristics of the stripe function. For example, based on prior knowledge that MLP rarely rises above 100 for silent regions in white noise, and structured background noise typically raises MLP to values above its typical white-noise levels, a floor associated with thresholding an MLP function may be set at about 100. Thus, the threshold sweep may be started at the preset floor, for example, to potentially save on computation time.

In some implementations, an independent secondary attribute may be used to potentially improve the detection of segment boundaries. For example, in order to calculate a time-density attribute associated with segments (e.g., the number of segments per unit time), identification of the start and end points of the underlying utterance (also referred to herein as voice-boundaries) may be needed. In some implementations, locations of the voice boundaries may be determined independently from the segmentation information extracted from the stripe function. This is illustrated by way of an example shown in FIG. 3B. In this example, a threshold is being evaluated against the attribute—number of segments per unit time. In this example, even when the threshold is too high (at the level 375), the number of segments per unit time may appear to be reasonable when compared to that of the model. However, the threshold 375 is likely a poor choice because it fails to detect other segments (as represented by multiple other peaks of the plot 370) within the utterance. In such cases, an independent judgment of the voice boundaries may be useful in selecting an erroneous threshold (or other parameter) that could yield an incorrect set of segment boundaries.

In some implementations, a cumulative-sum-of-stripe-function technique may be used for independently detecting the voice boundaries in an utterance. In this technique, a cumulative sum of a phonation-related stripe function is calculated over the duration of the utterance, and a line is then fit on to a portion of the cumulative sum (for example, spanning 10% to 90% of the cumulative sum). Typically, a cumulative sum is well-fitted by such a line except at the ends, where background noises before or after the phonation may exist. The voice boundaries can be set at the intersection of the fitted line with the limits of the cumulative sum. This can be done independently of the segmentation information extracted from the stripe function, and may be useful in effectively discarding spurious segments that are far from the true phonation region (also referred to as the voice-on region). In some implementations, for each utterance, any segment that doesn't at least partly overlap with the voice-on region can be eliminated from further consideration. In some cases, this may be useful in avoiding trimming a segment that overhangs into the voice-on region. The cumulative-sum-of-stripe-function technique is described in additional detail in U.S. application Ser. No. 15/181,878, filed on Jun. 14, 2016 the entire content of which is incorporated herein by reference.

The particular examples of FIGS. 3A-3C use the threshold for a stripe function as the parameter that is varied in generating the candidate sets of segment boundaries. However, generation of the candidate sets of segment boundaries may also be parameterized by other parameters associated with the segmentation process. In some implementations, the stripe function may be smoothed using a window function (e.g., as illustrated in FIG. 2C), and one or more parameters of the window may be used as the parameters that are varied to generate the candidate sets of segment boundaries. Various smoothing processes may be used for the purposes described herein. In some implementations, the smoothing process may include convolving the raw data with a window function. In such cases, one or more of the width, shape and size of the window function may be selected as the parameter that is varied to generate the candidate sets of segment boundaries. In some implementations, generation of the candidate sets of segment boundaries may also be parameterized by the stripe function. For example, a first stripe function may be used for generating a first candidate set of segment boundaries and a second, different stripe function may be used in generating a second candidate set of segment boundaries. In some implementations, generating the candidate sets of segment boundaries may also be parameterized by a combination of two or more parameters.

In some implementations, the distribution of an attribute associated with an estimated set of segment boundaries is compared with a distribution of a corresponding attribute computed from the model or training corpus. The training corpus can include segments of speech that may be used for evaluating the performance of other segmentation processes. In some implementations, the model can include segment timing data corresponding to various attributes (e.g., segment widths, widths of gaps between segments, number of segments per utterance, number of segments per unit time, widths of duration between segment starting points, etc.) for multiple voice samples in the training corpus. Distributions for the various attributes may therefore be generated using the data corresponding to the multiple speakers. In some implementations, speaker-specific distributions are also possible. In some implementations, generating a distribution for an attribute based on the model can include generating an estimated cumulative distribution function (eCDF) from the observed data, smoothing the eCDF, and then taking the derivative. The derivative can represent the estimated PDF for the particular attribute. In some implementations, the raw PDF estimate may be smoothed by convolving with a Gaussian kernel of fixed width. This can be done, for example, done to avoid having any influence from local fluctuations in the empirical PDFs. In some cases, the smoothing can result in a spreading of the estimated distribution, in return for a more stable performance over various threshold values. For example, for attributes that are a function of time (e.g., gap width), a kernel with standard deviation of 20 milliseconds may be used. The distributions for the various attributes can be pre-computed from the training corpus and stored in a storage device (e.g., the storage device 140) accessible to the segmentation engine 135.

The training corpus can be chosen in various ways, depending on, for example, the underlying application. In some implementations, the training corpus for a speaker verification application can include segments on each person's enrollment data. This in turn can be used for the segmentation of the input speech samples representing the utterances to be verified. In some implementations, a more general training corpus (e.g., including voice samples from multiple speakers) may be used for applications such as speech recognition.

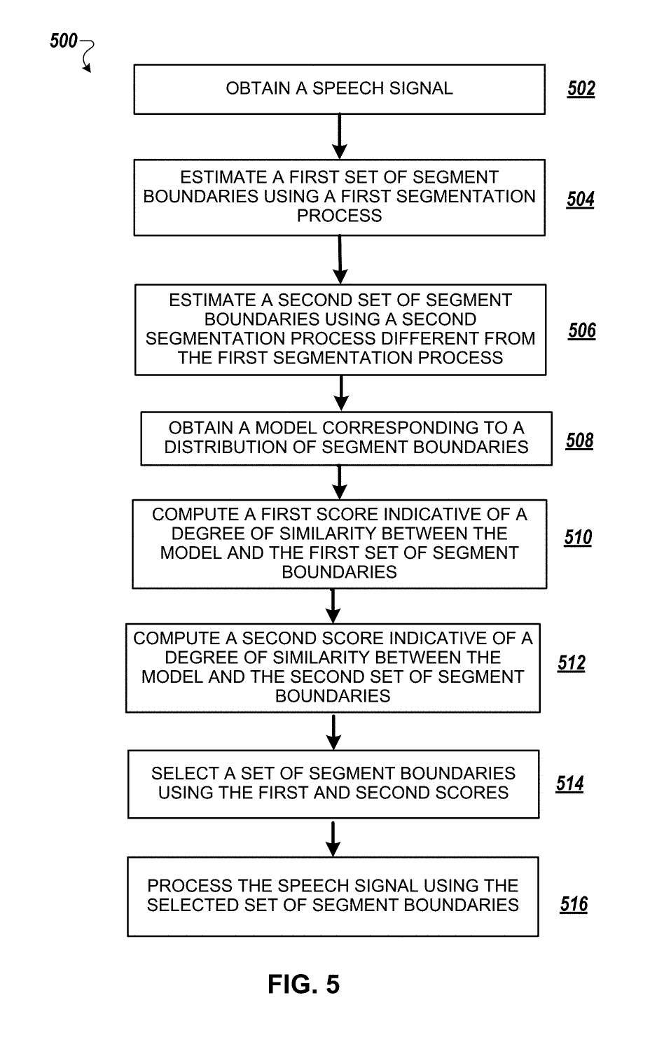

FIGS. 4A-4F are examples of distribution functions calculated from speech samples in a training corpus. A +12 dB white noise was added to the voice samples in the training corpus, and segmentation was performed by thresholding the MLP stripe function at a fixed threshold of 1000. The background conditions were carefully controlled for this otherwise clean training set, for the fixed threshold to yield accurate and reliable segmentation data. The value of 1000 was chosen empirically to yield segment boundaries right at the edge of phonation.

FIGS. 4A and 4B show The estimated PDF and CDF, respectively, for the attribute segment width derived from the training set described above. In both plots, both a raw unsmoothed curve, and a smoothed curve are shown. The raw estimated distribution is convolved with a Gaussian kernel of standard deviation 0.2 seconds to produce the smoothed curve. FIGS. 4C and 4D show the estimated PDF and CDF, respectively, for the attribute gap width derived from the training set described above. FIGS. 4E and 4F show the estimated PDF and CDF, respectively, for the attribute number of segments per second derived from the training set described above. These distribution functions may then be used for evaluating corresponding distribution functions computed from candidate sets of segment boundaries generated during run-time.

A distribution generated from a candidate set of segment boundaries can be compared with a model distribution in various ways. In some implementations, the two distributions may be compared using a goodness-of-fit process. This process can be illustrated using the following example where for one particular stripe-function threshold, the number of segments produced is denoted as Nₛ, and the set of attribute values for this set is denoted as {xᵢ}, where iε[1, . . . , Nₛ]. If the attribute is stack width, Nₛ is equal to the number of stacks, whereas for gap widths Nₛ is one less than the number of stacks. An assumption is made that for the optimal threshold choice, the observed values will be the best fit to the probability distribution estimated from the training data. The estimated probability density function (which may be referred to as the prior PDF) for a given attribute A is denoted as f_{A}(x), and the cumulative distribution function (which may be referred to as the prior CDF) is denoted as F_{A}(x). F_{A}(x) is defined as:

$${F}_{A} ( x ) = \frac{1}{N} {\sum }_{i = 1}^{N} {I}_{( - ∞ , x ]} ( {x}_{i} ) \qquad ( 33 )$$

where N is the number of samples of A, and 1≦i≦N. A goodness-of-fit test can be used to determine how well the distribution of the measured set {xᵢ} follows the expected distribution, as computed from the model.

Various goodness-of-fit tests can be used for measuring the similarity. In some implementations, a one-sample Kolmogorov-Smirnov test can be used. This may allow a comparison of the strengths of fit among multiple sets of data (e.g., the different candidate sets of segment boundaries produced, for example, by varying a parameter (e.g., threshold) of a segmentation process). For the one-sample Kolmogorov-Smirnov test, the estimated Cumulative Distribution Function (eCDF) of an attribute A for the sample data {xᵢ} can be computed as:

$${F}_{A}^{′} ( x ) = \frac{1}{{N}_{s}} {\sum }_{i = 1}^{{N}_{s}} {I}_{( - ∞ , x ]} ( {x}_{i} ) \qquad ( 34 )$$

where I_{(-∞,x]}, the indicator function, is equal to 1 if the input is less than x and zero otherwise. The test statistic—the maximum of the absolute difference between the prior CDF F_{A}(x) and the eCDF F′_{A}(x) measured across x—is given by:

$$D = {sup}_{x} \vert {F}_{A}^{′} ( x ) - {F}_{A} ( x ) \vert \qquad ( 35 )$$

Under a null hypothesis that xᵢ is distributed as F_{A}(x), in the limit as Nₛ→∞, \sqrt{Nₛ}D has a Kolmogorov distribution. In some implementations, the statistic and its p-value can be calculated using the “kstest” function available in the Matlab® software package developed by MathWorks Inc. of Natick, Mass. In some implementations, a goodness-of-fit measure or score for multiple attributes may be combined. For example, when using multiple segment-timing attributes (e.g. stack width and number of segments per second), the KS-test p-values for each attribute can be combined. Under the assumption that the attributes are substantially independent, we can use Fisher's method to combine their p-values. Under the null hypothesis, each p-value pⱼ for attribute jε[1, . . . , Nₐ] is a uniformly-distributed random variable over [0, 1], and the sum of their negative logarithms follows a chi-square distribution with 2Nₐ degrees of freedom when the null hypothesis is true. The sum is given by:

$$γ = - 2 {\sum }_{j = 1}^{{N}_{a}} log ( {p}_{j} ) \qquad ( 36 )$$

and the joint p-value across all attributes is given by:

$$p ( γ ) = 1 - {F}_{{χ}_{2 {N}_{a}}^{2}} ( γ ) \qquad ( 37 )$$

where

$${F}_{{χ}_{2 {N}_{a}}^{2}}$$

is the chi-square cumulative distribution function. In some implementations, the candidate threshold (or correspondingly, the candidate set of segment boundaries) for which the joint p-value across all attributes is the highest is selected for further processing steps.

In some implementations, multiple attributes may be combined even when the attributes are not strictly independent. For example, the technique described above may be resilient to a small amount of correlation among the attribute set because determining the location of an optimal threshold may not require precise values of the goodness-of-fit parameter. Because the optimal threshold is expected to cut through the middle of the stripe-function peaks, where large changes to ordinate value of a threshold crossing correspond to relatively small changes in abscissa value. Therefore, in some cases, moderate errors in threshold choices may not significantly affect determination of segment boundaries, thereby making the goodness-of-fit technique potentially applicable to combinations of attributes that are not strictly independent of one another.

In some implementations, a particular candidate parameter (e.g., threshold) can be selected as the parameter to use for further processing based on determining that the particular parameter substantially maximizes a density function of an attribute generated from the corresponding set of segment boundaries. For a particular attribute or statistic A, an empirical eCDF can be computed from the trusted training corpus as:

$${F}_{A} ( x ) = \frac{1}{N} {\sum }_{i = 1}^{N} {I}_{( - ∞ , x ]} ( {x}_{i} ) \qquad ( 38 )$$

where N is the number of samples of A, and 1≦i≦N. If F_{A} is noisy, it may be smoothed to reduce the effect of the noise. A derivative of F_{A} may be calculated to obtain a density function as:

$${f}_{A} ( x ) = \frac{d}{dx} {F}_{A} ( x ) \qquad ( 39 )$$

At runtime, a speech signal may be segmented in K different ways, and a corresponding density function \tilde{x}ₖ may be calculated for each. The maximum density can then be selected as:

$${f}_{A} ( {\tilde{x}}_{{k}^{*}} ) = {max}_{1 \leq k \leq K} {f}_{A} ( {\tilde{x}}_{k} ) \qquad ( 40 )$$

and the corresponding k* may be selected as the segmentation process of choice.

In some implementations, the density maximization technique described in equation (39) may be extended to multiple attributes that are assumed to be substantially independent. Specifically, for two independent attributes A and B, for which:

f_{A,B}(x,y)=f_{A}(x)f_{B}(y) (41)

the maximum joint density function can be selected as:

$${f}_{A , B} ( {\tilde{x}}_{{k}^{*}} , {\tilde{y}}_{{k}^{*}} ) = {max}_{1 \leq k \leq K} {f}_{A , B} ( {\tilde{x}}_{k} , {\tilde{y}}_{k} ) \qquad ( 42 )$$

and the corresponding k* may be selected as the segmentation process of choice. In some implementations, this may be extended to additional number of independent attributes.

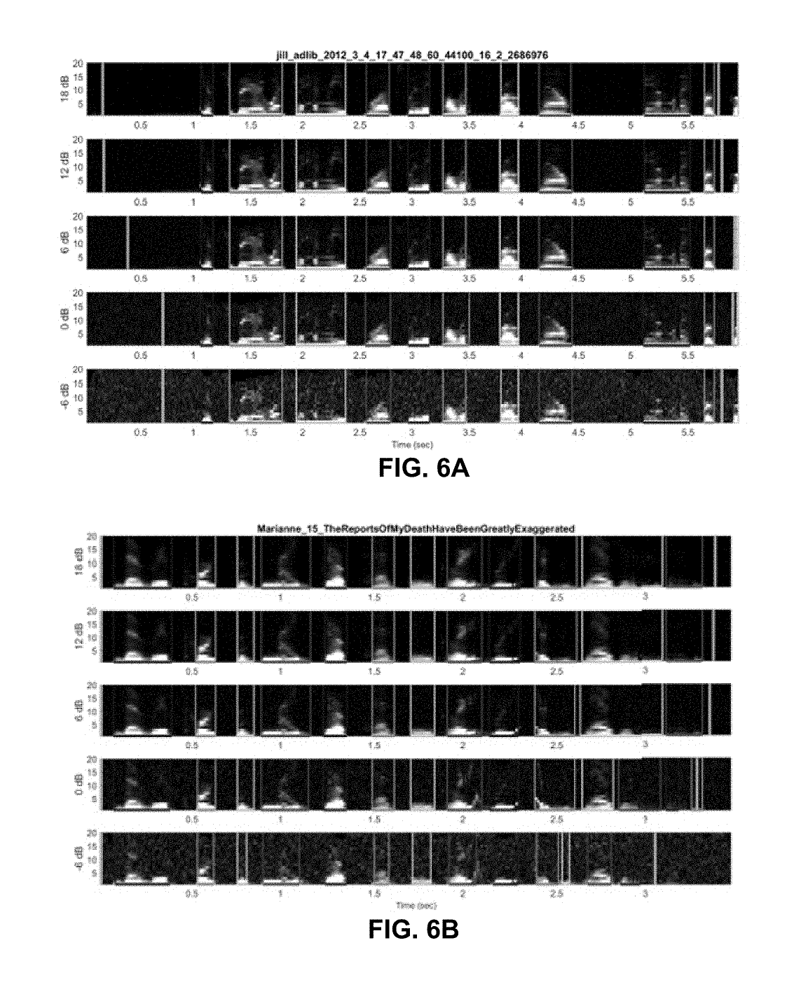

FIG. 5 is a flowchart of an example process 500 for determining segment boundaries in accordance with technology described herein. In some implementations, at least a portion of the process 500 may be executed by one or more processing devices on a server 105, for example, by the segmentation engine 135. Operations of the process 500 includes obtaining a speech signal (502). The speech signal may include input speech samples (e.g., the input speech samples 132) generated based on speech data received from a remote computing device such as a mobile device.

Operations of the process 500 also includes estimating a first set of segment boundaries from the speech signal, wherein the first set of segment boundaries are determined using a first segmentation process (504) and estimating a second set of segment boundaries using a second segmentation process (506). The second segmentation process is different from the first segmentation process at least with respect to one parameter associated with the segmentation processes. For example, if both the first segmentation process and the second segmentation process includes thresholding corresponding stripe functions, the second segmentation process may differ from the first segmentation process in the level of threshold chosen for determining the segment boundaries. In some implementations, the first segmentation process may be different from the second segmentation process with respect to multiple parameters. For example, the second segmentation process can use a different stripe function from that used by the first segmentation process.

In some implementations, estimating the first set of segment boundaries or the second set of segment boundaries can include obtaining a plurality of frequency representations by computing a frequency representation of each of multiple portions of the speech signal, and generating a time-varying data set using the plurality of frequency representations by computing a representative value of each frequency representation of the plurality of frequency representations. The representative value of each frequency representation can be the stripe function MLP associated with the frequency representation or an entropy of the frequency representation. The time varying data set can be a stripe function or entropy function as described above with reference to the segmentation process illustrated in FIGS. 2A-2C. The first or second set of segment boundaries can then be determined using the time-varying data set. Computing a frequency representation can include computing a stationary spectrum or an LLR spectrum corresponding to the portion of the speech signal.

Operations of the process 500 further includes obtaining a model corresponding to a distribution of segment boundaries (508). The model can be created by segmenting speech generated in a training corpus. In some implementations, the model includes one or more distribution functions pertaining to corresponding attributes of the segment boundaries of the segmented speech. Representation of the model can be stored, for example, in a storage device (e.g., the storage device 140 described above with reference to FIG. 1) accessible to the one or more computing devices executing the process 500.

Operations of the process 500 also includes computing a first score indicative of a degree of similarity between the model and the first set of segment boundaries (510) and computing a second score indicating a degree of similarity between the model and the second set of segment boundaries (512). Each of the first score and the second score can be indicative of one or more segment parameters associated with the model and the corresponding set of segment boundaries. A segment parameter can represent, for example, a density associated with an attribute of the segments, such as the number of segments/unit time, or a parameter of a distribution (e.g., CDF, PDF, or PMF) associated with an attribute of the segments. Computing the first score can include computing a first distribution function associated with the first set of boundaries, and computing the first score based on a degree of statistical similarity between (i) the first distribution function and (ii) the model. The first distribution function can be representative of an attribute associated with speech segments within the speech signal, and the model can be representative of the attribute associated with speech segments identified from speech signals in a training corpus. Computing the second score can include computing a second distribution function associated with the second set of boundaries, and computing the second score based on a degree of statistical similarity between (i) the second distribution function and (ii) the model. In some implementations, the second distribution function represents the same attribute as the first distribution function.

In some implementations, the attribute can include one or more of: a duration of speech segments, a width of time-gap between consecutive speech segments, a number of speech segments within an utterance, a number of speech segments per unit time, or a duration between starting points of consecutive speech segments. Each of the first distribution function and the second distribution function can be a cumulative distribution function (CDF) or a probability density function (PDF). Each of the first score and the second score can be indicative of a goodness-of-fit between the pre-computed distribution and the corresponding one of the first and second distribution function. In some implementations, the goodness-of-fit can be computed based on a Kolmogorov-Smirnov test between the pre-computed distribution and the corresponding one of the first and second distribution functions.

Operations of the process 500 further includes selecting a set of segment boundaries using the first score and the second score (514). This can include, for example, determining that the first score is higher than the second score, and responsive to such determination, selecting the first set of segment boundaries as the set of segment boundaries. The selection can also include determining that the second score is higher than the first score, and responsive to determining that the second score is higher than the first score, selecting the second set of segment boundaries as the set of segment boundaries. In general, the set of boundaries corresponding to the highest score may be selected for use in additional processing. In some implementations, the additional processing can include processing the speech signal using the selected set of segment boundaries (516). For example, the selected set of segment boundaries may be used in speech recognition, speaker recognition, or other speech classification applications.

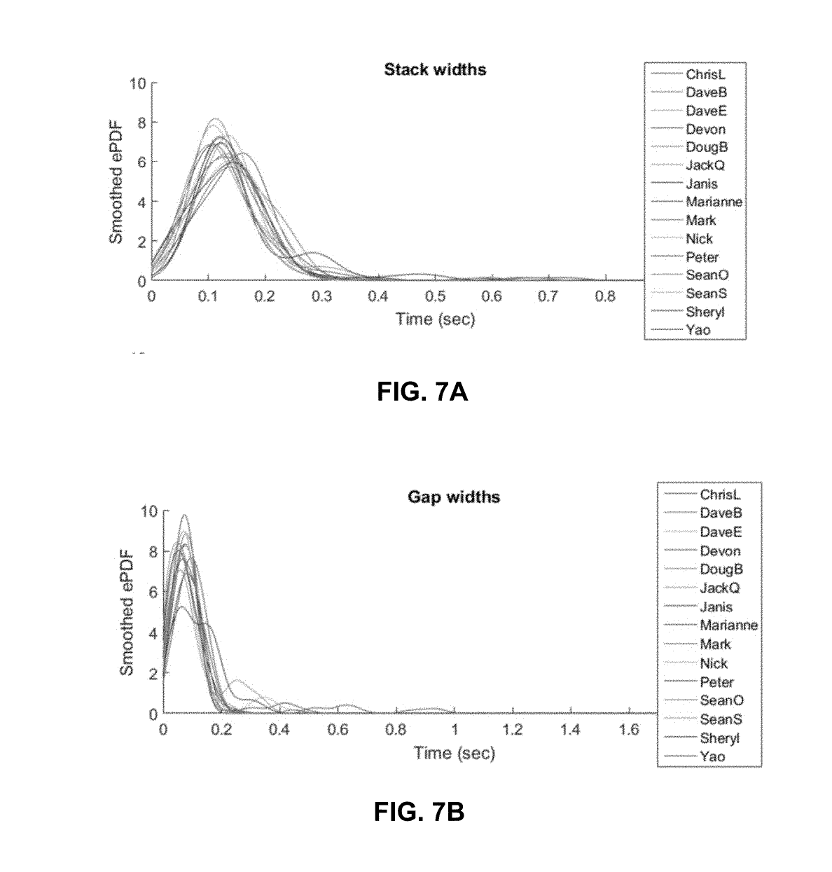

FIGS. 6A and 6B show two examples of segmentation results, wherein in each example, a single voice sample was segmented in increasing amounts of white noise. Specifically, the amount of noise was increased from +18 dB (top-most plot in each of FIGS. 6A and 6B) to −6 dB (lowermost plots in each of FIGS. 6A and 6B), and segment boundaries were estimated for each case using the segmentation technique described above. A training corpus was used to compute the model distributions against which candidate distributions were evaluated. The attributes used were segment-width and number-of-segments-per second. As illustrated in FIGS. 6A and 6B, the segment boundaries (indicated by the vertical lines in each plot) remained substantially at the same location even as the amount of noise was increased, thereby indicating a reliable performance for various noisy conditions.

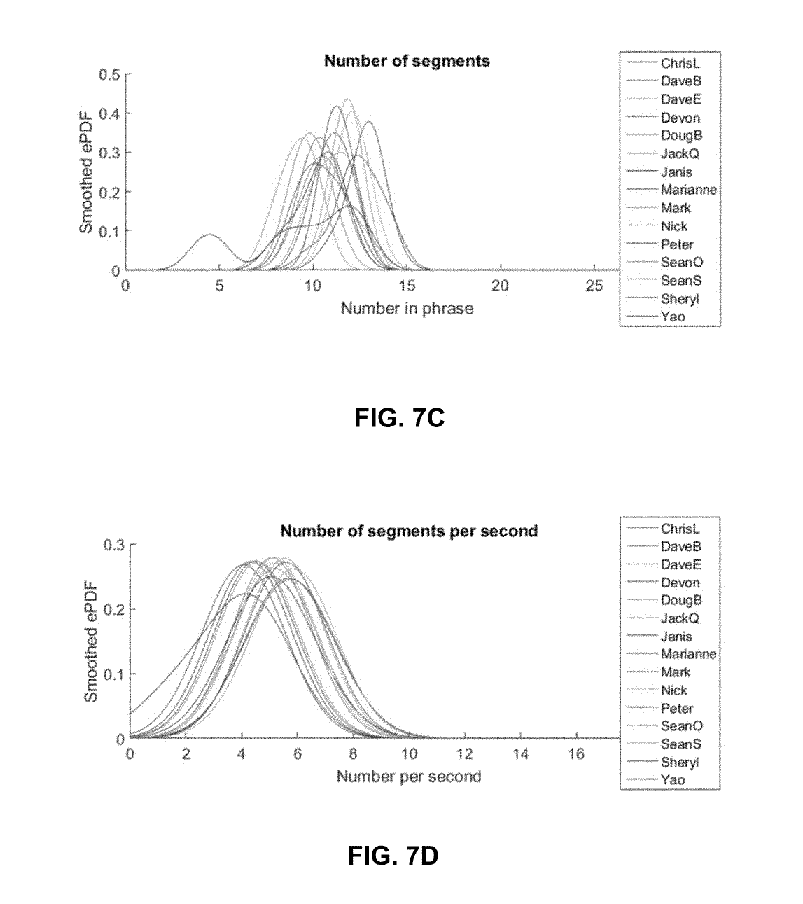

The model distributions may also be computed from a speaker-specific training corpus. This may be useful in certain applications, for example, in a speaker verification application where voice samples from each candidate speaker may be collected and stored (e.g., during an enrollment process). Speaker-specific training or model distributions may then be estimated from the enrollment training data, then applied to verify or recognize speech samples received during runtime. Examples of such speaker-specific distributions are shown in FIGS. 7A-7D for the attributes stack-widths, gap-widths, number-of-segments, and number-of-segments-per-second, respectively. Nine training replicates for used for constructing the speaker-specific distributions for each of fifteen speakers.

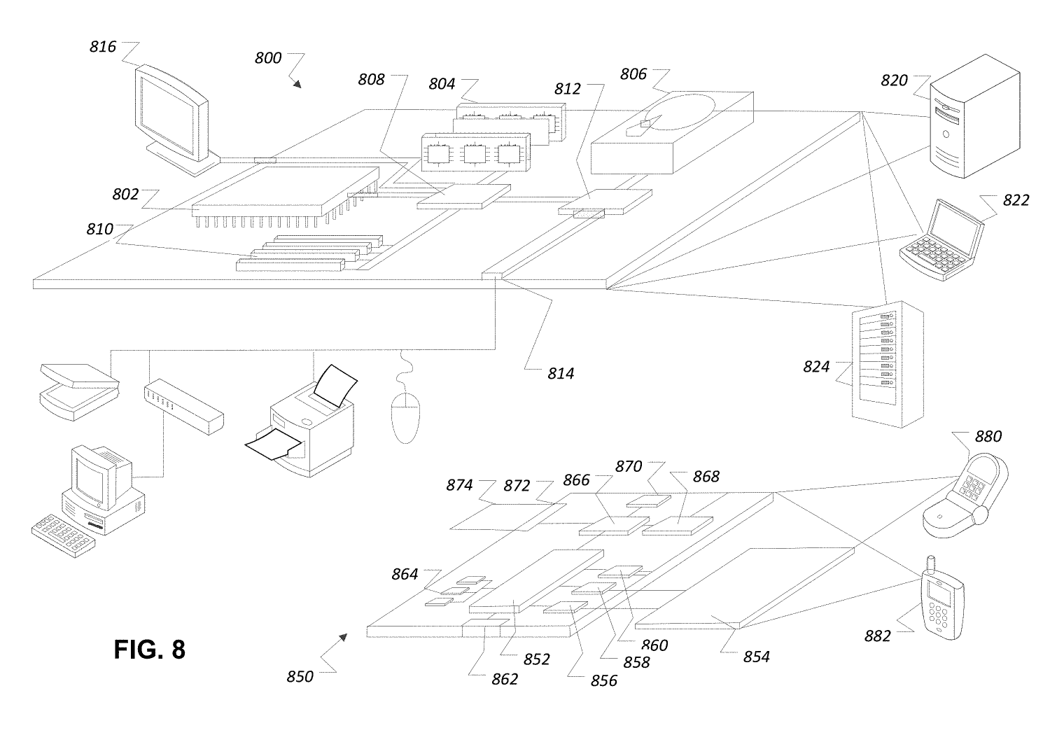

FIG. 8 shows an example of a computing device 800 and a mobile device 850, which may be used with the techniques described here. For example, referring to FIG. 1, the transformation engine 130, segmentation engine 135, speaker identification engine 120, and speech recognition engine 125, or the server 105 could be examples of the computing device 800. The device 107 could be an example of the mobile device 850. Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smartphones, tablet computers, e-readers, and other similar portable computing devices. The components shown here, their connections and relationships, and their functions, are meant to be examples only, and are not meant to limit implementations of the techniques described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In some implementations, the storage device 140 described in FIG. 1 can be an example of the storage device 806. In one implementation, the storage device 806 may be or contain a non-transitory computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, memory on processor 802, or a propagated signal.

The high speed controller 808 manages bandwidth-intensive operations for the computing device 800, while the low speed controller 812 manages lower bandwidth-intensive operations. Such allocation of functions is an example only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device, such as the device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provided as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, memory on processor 852, or a propagated signal that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, Wi-Fi, or other such transceiver (not shown). In addition, GPS (Global Positioning System) receiver module 870 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through an acoustic transducer or speaker, e.g., in a handset of device 850. Such sound may include sound from voice telephone calls, may include recorded sound (e.g., voice messages, music files, and so forth) and may also include sound generated by applications operating on device 850.

The computing device 850 may be implemented in a number of different forms, as shown in the figure. For example, it may be implemented as a cellular telephone 880. It may also be implemented as part of a smartphone 882, personal digital assistant, tablet computer, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback). Input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can be implemented in combination in a single implementation. Conversely, various features that are described in the context of a single implementation can be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a subcombination or variation of a subcombination. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

As such, other implementations are within the scope of the following claims.

What is claimed is:

1. A computer-implemented method comprising:
obtaining a speech signal;
estimating, by one or more processing devices, a first set of segment boundaries using the speech signal, wherein the first set of segment boundaries is determined using a first segmentation process;
estimating, by the one or more processing devices, a second set of segment boundaries using the speech signal, wherein the second set of segment boundaries is determined using a second segmentation process that is different from the first segmentation process;
obtaining a model corresponding to a distribution of segment boundaries;
computing a first score indicative of a degree of similarity between the model and the first set of segment boundaries;
computing a second score indicating a degree of similarity between the model and the second set of segment boundaries;
selecting a set of segment boundaries using the first score and the second score; and
processing the speech signal using the selected set of segment boundaries.

2. The method of claim 1, wherein computing the first score comprises:
computing, by the one or more processing devices, a first distribution function associated with the first set of boundaries, wherein the first distribution function is representative of an attribute associated with speech segments within the speech signal; and
computing, by the one or more processing devices, the first score based on a degree of statistical similarity between (i) the first distribution function and (ii) the model, the model being representative of the attribute associated with speech segments identified from speech signals in a training corpus.

3. The method of claim 2, wherein computing the second score comprises:
computing, by the one or more processing devices, a second distribution function associated with the second set of boundaries, wherein the second distribution function is also representative of the attribute; and
computing, by the one or more processing devices, the second score based on a degree of statistical similarity between (i) the second distribution function and (ii) the model.

4. The method of claim 1, wherein selecting the set of segment boundaries using the first score and the second score comprises:
determining that the first score is higher than the second score or the second score is higher than the first score;
responsive to determining that the first score is higher than the second score, selecting the first set of segment boundaries as the set of segment boundaries; and
responsive to determining that the second score is higher than the first score, selecting the second set of segment boundaries as the set of segment boundaries.

5. The method of claim 1, wherein estimating the first set of segment boundaries comprises:
obtaining a plurality of frequency representations by computing a frequency representation of each of multiple portions of the speech signal;
generating, by one or more processing devices, a time-varying data set using the plurality of frequency representations by computing a representative value of each frequency representation of the plurality of frequency representations; and
determining, by the one or more processing devices, the first set of segment boundaries using the time-varying data set.

6. The method of claim 5, wherein the representative value of each frequency representation is a stripe function value associated with the frequency representation.

7. The method of claim 5, wherein computing the frequency representation comprises computing a stationary spectrum.

8. The method of claim 5, wherein the representative value of each frequency representation is an entropy of the frequency representation.

9. The method of claim 1, wherein the first segmentation process is different from the second segmentation process with respect to a parameter associated with each of the segmentation processes.

10. The method of claim 2, wherein the attribute comprises one of: a duration of speech segments, a width of time-gap between consecutive speech segments, a number of speech segments within an utterance, a number of speech segments per unit time, or a duration between starting points of consecutive speech segments.

11. The method of claim 3, wherein each of the first distribution function and the second distribution function is a cumulative distribution function (CDF).

12. The method of claim 3, wherein each of the first distribution function and the second distribution function is a probability density function (PDF).

13. The method of claim 3, wherein each of the first score and the second score is indicative of a goodness-of-fit between the model and the corresponding one of the first and second distribution function.

14. The method of claim 13, wherein the goodness-of-fit is computed based on a Kolmogorov-Smirnov test between the model and the corresponding one of the first and second distribution functions.

15. The method of claim 1, wherein processing the speech signal comprises performing one of: speech recognition or speaker identification.

16. A system comprising:
memory; and
one or more processing devices configured to:
obtain a speech signal,
estimate a first set of segment boundaries using the speech signal, wherein the first set of segment boundaries is determined using a first segmentation process,
estimate a second set of segment boundaries using the speech signal, wherein the second set of segment boundaries is determined using a second segmentation process that is different from the first segmentation process,
obtain a model corresponding to a distribution of segment boundaries,
compute a first score indicative of a degree of similarity between the model and the first set of segment boundaries,
compute a second score indicating a degree of similarity between the model and the second set of segment boundaries,
select a set of segment boundaries using the first score and the second score, and
process the speech signal using the selected set of segment boundaries.

17. The system of claim 16, wherein wherein the one or more processing devices are configured to:
compute a first distribution function associated with the first set of boundaries, wherein the first distribution function is representative of an attribute associated with speech segments within the speech signal; and
compute the first score based on a degree of statistical similarity between (i) the first distribution function and (ii) the model, the model being representative of the attribute associated with speech segments identified from speech signals in a training corpus.

18. The system of claim 17, wherein the one or more processing devices are further configured to:
compute a second distribution function associated with the second set of boundaries, wherein the second distribution function is also representative of the attribute; and
compute the second score based on a degree of statistical similarity between (i) the second distribution function and (ii) the model.

19. The system of claim 16, wherein selecting the set of segment boundaries using the first score and the second score comprises:
determining that the first score is higher than the second score or the second score is higher than the first score;
responsive to determining that the first score is higher than the second score, selecting the first set of segment boundaries as the set of segment boundaries; and
responsive to determining that the second score is higher than the first score, selecting the second set of segment boundaries as the set of segment boundaries.

20. The system of claim 16, wherein estimating the first set of segment boundaries comprises:
obtaining a plurality of frequency representations by computing a frequency representation of each of multiple portions of the speech signal;
generating a time-varying data set using the plurality of frequency representations by computing a representative value of each frequency representation of the plurality of frequency representations; and
determining the first set of segment boundaries using the time-varying data set.

21. The system of claim 20, wherein the representative value of each frequency representation is one of a stripe function value or entropy value associated with the frequency representation.

22. The system of claim 20, wherein the frequency representation is computed by computing a stationary spectrum.

23. The system of claim 16, wherein the first segmentation process is different from the second segmentation process with respect to a parameter associated with each of the segmentation processes.

24. The system of claim 17, wherein the attribute comprises one of: a duration of speech segments, a width of time-gap between consecutive speech segments, a number of speech segments within an utterance, a number of speech segments per unit time, or a duration between starting points of consecutive speech segments.

25. The system of claim 18, wherein each of the first score and the second score is indicative of a goodness-of-fit between the model and the corresponding one of the first and second distribution function.

26. The system of claim 16, further comprising a speech recognition engine to perform speech recognition or a speaker identification engine to perform speaker identification.

27. One or more machine-readable storage devices having encoded thereon computer readable instructions for causing one or more processors to perform operations comprising:
obtaining a speech signal;
estimating a first set of segment boundaries using the speech signal, wherein the first set of segment boundaries is determined using a first segmentation process;
estimating a second set of segment boundaries using the speech signal, wherein the second set of segment boundaries is determined using a second segmentation process that is different from the first segmentation process;
obtaining a model corresponding to segment boundaries;
computing a first score indicative of a degree of similarity between the model and the first set of segment boundaries;
computing a second score indicating a degree of similarity between the model and the second set of segment boundaries;
selecting a set of segment boundaries using the first score and the second score; and
processing the speech signal using the selected set of segment boundaries.

28. The one or more machine-readable storage devices of claim 27, wherein computing the first score comprises:
computing a first distribution function associated with the first set of boundaries, wherein the first distribution function is representative of an attribute associated with speech segments within the speech signal; and
computing the first score based on a degree of statistical similarity between (i) the first distribution function and (ii) the model, the model being representative of the attribute associated with speech segments identified from speech signals in a training corpus.

29. The one or more machine-readable storage devices of claim 28, wherein computing the second score comprises:
computing a second distribution function associated with the second set of boundaries, wherein the second distribution function is also representative of the attribute; and
computing the second score based on a degree of statistical similarity between (i) the second distribution function and (ii) the model.

30. The one or more machine-readable storage devices of claim 27, wherein estimating the first set of segment boundaries comprises:
obtaining a plurality of frequency representations by computing a frequency representation of each of multiple portions of the speech signal;
generating a time-varying data set using the plurality of frequency representations by computing a representative value of each frequency representation of the plurality of frequency representations; and
determining the first set of segment boundaries using the time-varying data set.
